(19) United States
(12) Patent Application Publication
(10) Pub. No.: US 2002/0110446 A1
(43) Pub. Date: Aug. 15, 2002

(54) Forklift attachment for rolled flooring

(76) Inventor: Bryan Smith, Ruidoso, NM (US)

Correspondence Address: Richard W. Goldstein, 2071 Clove Road, Staten Island, NY, 10304, US

(21) Appl. No.: 09/781,899

(22) Filed: Feb. 9, 2001

(51) Int. Cl. B66F 1/00

(52) U.S. Cl. 414/607; 414/911

(57) ABSTRACT

A forklift attachment for rolled flooring including a pair of hollow supports each having open inner ends. The pairs of hollow supports are arranged in a side-by-side orientation. The open inner ends receive the pair of drive forks of the forklift therein. Pairs of support braces are secured to and extend upwardly from the pair of hollow supports. An elongated pole is secured to and extends laterally from the support braces. The elongated pole has an inner end and an outer end. The inner end is secured to an inner most of the support braces. The outer end extends outwardly to a position beyond the hollow supports whereby a free length of the elongated pole can support a roll of flooring thereon.

### BACKGROUND OF THE INVENTION

The present invention relates to a forklift attachment for rolled flooring and more particularly pertains to allowing rolls of flooring to be easily moved.

People who work in places that sell rolls of carpet and other rolled flooring know how heavy these items are, and know how difficult they are to move. Forklifts can be used, but are sometimes ineffective because of the danger associated with the rolls potentially rolling off of the forks. Since these items are typically heavy, the chance for injury is great. Forklifts are items that most flooring suppliers have in their warehouse to perform various tasks. Thus, to better utilize the forklift in this industry, it would be a novel concept to provide an adapter for the forklift that will allow it to transport rolls of carpet and other rolled flooring from one place to another in a safe and efficient manner.

The present invention attempts to solve the abovementioned problem by providing a device that is deigned specifically for use with forklifts with the intended purpose of allowing rolls of carpet and other flooring materials to be transported in a safe and efficient manner.

The use of article lifting devices is known in the prior art. More specifically, article lifting devices heretofore devised and utilized for the purpose of handling and lifting articles are known to consist basically of familiar, expected and obvious structural configurations, notwithstanding the myriad of designs encompassed by the crowded prior art which have been developed for the fulfillment of countless objectives and requirements.

By way of example, U.S. Pat. No. 4,050,599 to Bender discloses an attachment for a fork lift truck capable of being used to carry rolls of carpet. U.S. Pat. Nos. 5,658,124 to Presnell, III and 5,688,098 to Theno disclose various roll handling devices.

While these devices fulfill their respective, particular objective and requirements, the aforementioned patents do not describe a forklift attachment for rolled flooring for allowing rolls of flooring to be easily moved.

In this respect, the forklift attachment for rolled flooring according to the present invention substantially departs from the conventional concepts and designs of the prior art, and in doing so provides an apparatus primarily developed for the purpose of allowing rolls of flooring to be easily moved.

Therefore, it can be appreciated that there exists a continuing need for a new and improved forklift attachment for rolled flooring which can be used for allowing rolls of flooring to be easily moved. In this regard, the present invention substantially fulfills this need.

### SUMMARY OF THE INVENTION

In the view of the foregoing disadvantages inherent in the known types of article lifting devices now present in the prior art, the present invention provides an improved forklift attachment for rolled flooring. As such, the general purpose of the present invention, which will be described subsequently in greater detail, is to provide a new and improved forklift attachment for rolled flooring which has all the advantages of the prior art and none of the disadvantages.

To attain this, the present invention essentially comprises a pair of hollow supports each having open inner ends and open outer ends. The pairs of hollow supports are arranged in a side-by-side orientation. The open inner ends receive the pair of drive forks of the forklift therein. The pairs of hollow supports each have a pair of short supports secured to outer edges thereof inwardly of the open inner and outer ends thereof. Pairs of support braces are secured to and extend upwardly from the pair of hollow supports. One of the support braces is disposed inwardly of the open inner ends of the hollow supports. Another of the support braces is disposed inwardly of the open outer ends of the hollow supports. The support braces have a generally trapezoidal configuration defined by a wide lower end and a narrow upper end. The support braces each have a pair of support gussets disposed on respective wide lower ends and the respective support brace. An elongated pole is secured to and extends laterally from the narrow upper ends of the support braces. The elongated pole has an inner end and an outer end. The inner end is secured to an innermost of the support braces. The outer end extends outwardly to a position beyond the hollow supports whereby a free length of the elongated pole can support a roll of flooring thereon.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved forklift attachment for rolled flooring which has all the advantages of the prior art article lifting devices and none of the disadvantages.

It is another object of the present invention to provide a new and improved forklift attachment for rolled flooring which may be easily and efficiently manufactured and marketed.

It is a further object of the present invention to provide a new and improved forklift attachment for rolled flooring which is of durable and reliable construction.

An even further object of the present invention is to provide a new and improved forklift attachment for rolled flooring which is susceptible of a low cost of manufacture with regard to both materials and labor, and which accordingly is then susceptible of low prices of sale to the consuming public, thereby making such forklift attachment for rolled flooring economically available to the buying public.

Even still another object of the present invention is to provide a new and improved forklift attachment for rolled flooring for allowing rolls of flooring to be easily moved.

Lastly, it is an object of the present invention to provide a new and improved forklift attachment for rolled flooring including a pair of hollow supports each having open inner ends. The pair of hollow supports are arranged in a side-by-side orientation. The open inner ends receive the pair of drive forks of the forklift therein. Pairs of support braces are secured to and extend upwardly from the pair of hollow supports. An elongated pole is secured to and extends laterally from the support braces. The elongated pole has an inner end and an outer end. The inner end is secured to an inner most of the support braces. The outer end extends outwardly to a position beyond the hollow supports whereby a free length of the elongated pole can support a roll of flooring thereon.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of the preferred embodiment of the forklift attachment for rolled flooring constructed in accordance with the principles of the present invention.

FIG. 2 is a perspective view of the present invention illustrated in use.

The same reference numerals refer to the same parts through the various figures.

### DESCRIPTION OF THE PREFERRED EMBODIMENT

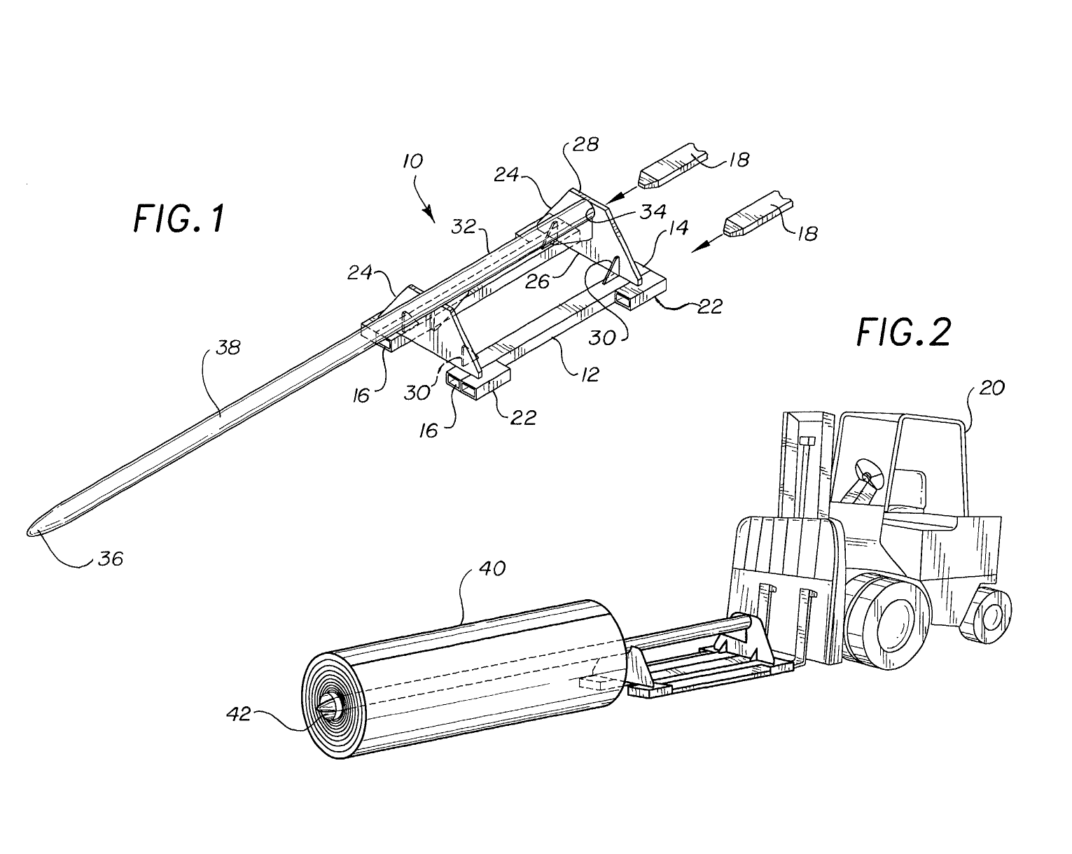

With reference now to the drawings, and in particular, to FIGS. 1 through 2 thereof, the preferred embodiment of the new and improved forklift attachment for rolled flooring embodying the principles and concepts of the present invention and generally designated by the reference number 10 will be described.

Specifically, it will be noted in the various Figures that the device relates to a forklift attachment for rolled flooring for allowing rolls of flooring to be easily moved. In its broadest context, the device consists of a pair of hollow supports, a pair of support braces, and an elongated pole. Such components are individually configured and correlated with respect to each other so as to attain the desired objective.

The pair of hollow supports 12 each have open inner ends 14 and open outer ends 16. The pair of hollow supports 12 are arranged in a side-by-side orientation. Note FIG. 1. The open inner ends 14 receive the pair of drive forks 18 of the forklift 20 therein. Note FIG. 2. The pair of hollow supports 12 each have a pair of short supports 22 secured to outer edges thereof inwardly of the open inner and outer ends 14, 16 thereof. The arrangement of the pair of hollow supports 12 will correspond with the type of forklift used. Different types of forklifts may space their drive forks in different ways whereby the present invention can be adapted for, and anticipates these variation.

The pair of support braces 24 are secured to and extend upwardly from the pair of hollow supports 12. One of the support braces 24 is disposed inwardly of the open inner ends 14 of the hollow supports 12. Another of the support braces 24 is disposed inwardly of the open outer ends 16 of the hollow supports 12. The support braces 24 have a generally trapezoidal configuration defined by a wide lower end 26 and a narrow upper end 28. The support braces 24 each have a pair of support gussets 30 disposed on respective wide lower ends 26 and the respective support brace 12.

The elongated pole 32 is secured to and extends laterally from the narrow upper ends 28 of the support braces 24. The elongated pole 32 has an inner end 34 and an outer end 36. The inner end 34 is secured to an innermost of the support braces 24. The outer end 36 extends outwardly to a position beyond the hollow supports 12 whereby a free length 38 of the elongated pole 32 can support a roll of flooring 40 thereon. Note FIG. 2. Once the elongated pole 32 is positioned within a spool 42 that supports the roll of flooring 40, the forklift 20 can be maneuvered to move the roll of flooring 40 to the desired location. The drive forks 18 will only need to be raised if the thickness or diameter of the roll of flooring 40 dictates as such.

As to the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and the manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modification and changes will readily occur to those skilled in the art, it is not desired to limit the invention to the exact construction and operation shown and described, and accordingly, all suitable modification and equivalents may be resorted to, falling within the scope of the invention.

What is claimed as being new and desired to be protected by Letters Patent of the United States is as follows:

1. A forklift attachment for rolled flooring for allowing rolls of flooring to be easily moved, wherein the forklift includes a pair of drive forks extending outwardly therefrom, the attachment comprising, in combination:
a pair of hollow supports each having open inner ends and open outer ends, the pair of hollow supports being arranged in a side-by-side orientation, the open inner ends receiving the pair of drive forks of the forklift thereon, the pair of hollow supports each having a pair of short supports secured to outer edges thereof inwardly of the open inner and outer ends thereof;
a pair of support braces secured to and extending upwardly from the pair of hollow supports, one of the support braces being disposed inwardly of the open inner ends of the hollow supports, another of the support braces being disposed inwardly of the open outer ends of the hollow supports, the support braces having a generally trapezoidal configuration defined by a wide lower end and a narrow upper end, the support braces each having pair of support gussets disposed on respective wide lower ends and the respective support brace; and
an elongated pole secured to and extending laterally from the narrow upper ends of the support braces, the elongated pole having an inner end and an outer end, the inner end being secured to an inner most of the support braces, the outer end extending outwardly to a position beyond the hollow supports whereby a free length of the elongated pole can support a roll of flooring thereon.

2. A forklift attachment for rolled flooring for allowing rolls of flooring to be easily moved, wherein the forklift includes a pair of drive forks extending outwardly therefrom, the attachment comprising, in combination:
a pair of hollow supports each having open inner ends, the pair of hollow supports being arranged in a side-by-side orientation, the open inner ends receiving the pair of drive forks of the forklift thereon;
a pair of support braces secured to and extending upwardly from the pair of hollow supports; and
an elongated pole secured to and extending laterally from the support braces, the elongated pole having an inner end and an outer end, the inner end being secured to an innermost of the support braces, the outer end extending outwardly to a position beyond the hollow supports whereby a free length of the elongated pole can support a roll of flooring thereon.

3. The forklift attachment for rolled flooring as set forth in claim two, wherein the pairs of hollow supports each have a pair of short supports secured to outer edges thereof inwardly of the open inner and outer ends thereof.

4. The forklift attachment for rolled flooring as set forth in claim two, wherein one of the support braces is disposed inwardly of the open inner ends of the hollow supports, another of the support braces being disposed inwardly of the open outer ends of the hollow supports.

5. The forklift attachment for rolled flooring as set forth in claim two, wherein the support braces have a generally trapezoidal configuration defined by a wide lower end and a narrow upper end.

6. The forklift attachment for rolled flooring as set forth in claim two, wherein the support braces each have a pair of support gussets disposed on lower ends thereof and a respective support brace.
